(19) United States
(12) Patent Application Publication
(10) Pub. No.: US 2026/0170033 A1
(43) Pub. Date: Jun. 18, 2026

(54) CONTEXT CONSTRUCTION AND QUERY RESPONSE GENERATION

(71) Applicant: Insight Direct USA, Inc., Chandler, AZ (US)

(72) Inventors: Shreya Suparna Sreekantham, Chandler, AZ (US); Elijah Paul Child, Provo, UT (US); Jakob Liam Symchych, San Antonio, TX (US); Anh Quang Phan, Northfield, MN (US); Kotoe Takeda, Peachtree City, GA (US); Preston Carter DeLeo, Saint Augustine, FL (US)

(21) Appl. No.: 19/384,404

(22) Filed: Nov. 10, 2025

Related U.S. Application Data
(60) Provisional application No. 63/719,450, filed on Nov. 12, 2024.

(51) Int. Cl. G06F 16/334; G06F 40/134; G06F 40/169; G06F 40/40

(52) U.S. Cl. CPC G06F 16/3344; G06F 16/3347; G06F 40/134; G06F 40/169; G06F 40/40

(57) ABSTRACT

A user request is received by the processor of a network-connected device. The user request includes a natural-language prompt and build data. The build data identifies one or more databases and provides a target count for building context to generate a responsive answer to the user request. A language model queries the one or more databases identified by the build data to generate information responsive to the prompt. Modified information is constructed based on the initial information generated by the language model and based on the target count provided by the context identifier. A responsive prompt is generated based on the modified information and the natural-language prompt. The language model is provided with the responsive prompt to generate responsive text.

### CROSS-REFERENCE TO RELATED APPLICATION

This application is a nonprovisional application claiming the benefit of U.S. provisional Ser. No. 63/719,450, filed Nov. 12, 2024, and entitled “CONTEXT CONSTRUCTION AND QUERY RESPONSE GENERATION,” the disclosure of which is hereby incorporated by reference in its entirety.

### BACKGROUND

This disclosure relates generally to context construction for generative language models. More specifically, this disclosure relates to systems and methods for providing uniquely built context for generating answers to natural-language prompts.

Generative artificial intelligence (AI) language models, such as large language models and/or transformer models, are capable of dynamically generating content based on user prompts. Some language models are capable of generating human-like text and can be incorporated into text chat programs in order to mimic the experience of interacting with a human in a text chat.

Human-generated prompts can be augmented with additional information to provide context to the language model and improve the accuracy and/or relevance of natural-language generated by the model in response to a prompt.

Entities, such as companies, often maintain databases of articles that are utilized to preserve and share institutional knowledge. For example, companies can be required to answer security assessment questionnaires (SAQs) prior to engaging with outside entities (e.g., vendors and/or customers). Such SAQs can be lengthy and include many questions regarding internal policies and procedures; how such policies and procedures are implemented; and regarding the use of security to protect various assets; among other things. Some outside entities can require answering of multiple SAQs, such as on a periodic basis (e.g., annually, bi-annually, semi-annually, etc.). Each SAQ can include multiple distinct questions, up to hundreds of questions. The SAQs submitted by different entities can be slightly different and nuanced relative to each other, such as varying based on region, country, need, industry, type of engagement, etc. Typically, SAQs are reviewed by a dedicated response team that reviews the SAQ and answers the questions. Such review process can be lengthy and the response team may be answering the same question, but phrased slightly differently, many times. Internal policies and procedures can be maintained in one or more databases forming a policy center, but the information can be spread out and require manual retrieval to complete each SAQ.

### SUMMARY

According to one aspect of the present disclosure, a method includes receiving, by a processor of a response generator, a user request including a natural-language prompt and build data, the response generator formed as a network-connected device, the build data including a first database identifier selected from a plurality of database identifiers and a first target count associated with the first database identifier; querying, by a language model, a first vector database identified by the first database identifier based on the natural-language prompt to retrieve first initial information, wherein the first vector database comprises a first plurality of vectors, each vector of the first plurality of vectors is representative of a text segment of a first plurality of text segments, the first plurality of text segments generated based on a first plurality of documents, and the first initial information includes text segments of the first plurality of text segments; generating, by the response generator in response to receiving the first initial information, modified response information including a first count of text segments of the first plurality of text segments, the modified response information based on the first initial information and the build data, and the first count of text segments generated based on the first target count; generating, by the response generator, a responsive prompt based on the modified response information and the natural-language prompt; providing, by the response generator, the responsive prompt to the language model to generate natural-language responsive text; and outputting, by the response generator, a responsive output that includes the natural-language responsive text.

According to an additional or alternative aspect of the present disclosure, a method includes receiving, by a processor of a response generator formed as a network-connected device, a user request including a natural-language prompt and build data, the build data including first filter criteria for a first database and second filter criteria for a second database; iteratively querying, by a language model, a first vector database identified by the first filter criteria based on the natural-language prompt to retrieve first initial information, wherein the first vector database comprises a first plurality of vectors, each vector of the first plurality of vectors is representative of a text segment of a first plurality of text segments, the first plurality of text segments generated based on a first plurality of documents, and the first initial information includes at least one text segment of the first plurality of text segments; iteratively querying, by the language model, a second vector database identified by the second filter criteria based on the natural-language prompt to retrieve second initial information, wherein the second vector database comprises a second plurality of vectors, each vector of the second plurality of vectors is representative of a text segment of a second plurality of text segments, the second plurality of text segments generated based on a second plurality of documents, and the second initial information includes at least one text segment of the second plurality of text segments; generating, by the response generator, modified response information based on the first initial information, a first target count from the first filter criteria, the second initial information, and a second target count from the second filter criteria, the modified response information including a first count of text segments from the first initial information based on the first target count, and the modified response information including a second count of text segments from the second initial information, the first count of text segments generated based on the first target count and the second count of text segments based on the second target count; generating, by the response generator, a responsive prompt based on the modified response information and the natural-language prompt; providing, by the response generator, the responsive prompt to the language model to generate natural-language responsive text; and outputting, by the response generator, a responsive output that includes the natural-language responsive text.

According to another additional or alternative aspect of the present disclosure, a method includes receiving, by a processor of a response generator formed as a network-connected device, a natural-language prompt and build data, the build data including a first database identifier selected from a plurality of database identifiers, and a first target count selected from a first plurality of target counts; querying, by a language model, a first vector database identified by the first database identifier and based on the natural-language prompt to retrieve first initial information, wherein the first vector database comprises a first plurality of vectors, each vector of the first plurality of vectors is representative of a text segment of a first plurality of text segments, the first plurality of text segments are generated based on a first plurality of documents, and the first initial information includes at least one text segment of the first plurality of text segments; generating, by the response generator, modified response information based on the first initial information and the build data, wherein the response generator filters the first initial information based on a source document identifier for the text segments of the first plurality of text segments, the modified response information including a first count of text segments of the first plurality of text segments, the first count of text segments generated based on the first target count; generating, by the response generator, a responsive prompt based on the modified response information and the natural-language prompt; providing, by the response generator, the responsive prompt to the language model to generate natural-language responsive text; and outputting, by the response generator, a responsive output that includes the natural-language responsive text. The response generator is configured to include a first text segment from the first initial information in the modified response information and omit a second text segment from the first initial information from the modified response information based on a relevancy score of the first text segment being higher than a relevancy score of the second text segment and based on the first text segment and the second text segment having a common source document.

### BRIEF DESCRIPTION OF THE DRAWINGS

FIG. 1 is a block diagram illustrating a response generation system.

FIG. 2 is a flowchart illustrating a method of generating a responsive output by a filtered query approach.

### DETAILED DESCRIPTION

The present disclosure is directed to systems and methods for generating and providing responsive outputs to natural-language prompts. As explained in more detail herein, the systems and methods of the present disclosure enable building specific context for a user-supplied request for querying one or more vector databases. A response generator, which can be implemented as a web application among other options, causes a language model, such as a large language model (LLM), to query the one or more vector databases based on the user-supplied request, including a user-supplied prompt. The response generator causes the language model to query one or more databases based on a user-supplied prompt from the user request. The response generator builds modified response information based on initial response information retrieved by the language model in response to the user-supplied prompt. The response generator generates a responsive prompt based on the modified response information and the natural-language prompt from the user. The response generator causes the language model to generate natural language responsive text in response to the responsive prompt. The response generator can provide the generated responsive text to the user as a response to the initial user-supplied prompt.

The user request can include the user-supplied prompt and build data. The build data provides instructions to the response generator for building the modified response information. The build data can include one or more database identifiers. The database identifier provides the identity of a database to be queried by the language model to generate the initial information. The build data can, additionally or alternatively, include a target count. The target count can define a target number of datapoints for forming the modified response information. For example, the build data can specify that the modified responsive information includes four pieces of information (e.g., as specified by the target count) pulled from a first database (e.g., as based on the database identifier).

The response generator can be configured to build the modified response information based on relevance of the initial response information to user-supplied prompt as determined by the language model. In some examples, the response generator is configured to filter the information retrieved by the language model. For example, the response generator can be configured to filter the information to prevent source redundancy. In some examples, the response generator is configured to filter the information based on source document identity to limit the information in the modified response information that comes from any single source. In some such examples, the response generator can utilize less relevant information over more relevant information based on the less relevant information based on the less relevant information coming from a unique source, as discussed in more detail below.

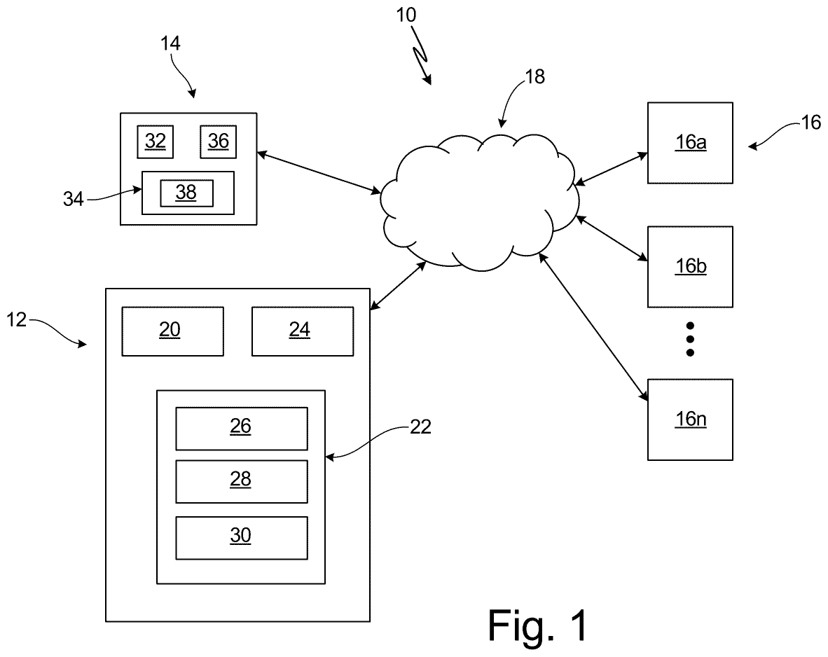

FIG. 1 is a block diagram of response generation system 10. System 10 includes response generator 12, user device 14, databases 16a-16n (collectively herein “database 16” or “databases 16”), and network 18. Response generator 12 includes control circuitry 20, memory 22, and user interface 24. Memory 22 is configured to store chat module 26, context generation module 28, and language generation module 30. User device 14 includes device control circuitry 32, device memory 34, and device user interface 36. As will be explained in more detail subsequently, system 10 uses a filtered query approach to retrieve contextual information from one or more databases that is used to build prompt context for answering the prompt by a language model, reducing fabrications (e.g., AI hallucinations) created by the language model and also increasing the accuracy of responses generated by the language model, the consistency of responses generated by the language model, as well as the value of those responses for users.

The filtered query approach detailed herein uses database queries to retrieve information from one or multiple databases. The information retrieved from the one or more databases can be referred to as initial response information. The retrieved initial response information can be filtered to select a subgroup of the initial response information. The subgroup of initial response information can be generated based on one or more filter criteria. For example, the filter criteria can define a count of pieces of information utilized to generate the subgroup, can define databases from which the pieces of information are retrieved, can define uniqueness criteria, among other options. The filtered information is utilized to generate modified response information. The modified response information forms prompt context for generating a responsive output.

Response generator 12 is configured to generate and provide responsive outputs to user requests. Response generator 12 is configured to store software, implement functionality, and/or process instructions. The response generator 12 can be of any suitable configuration for gathering data, processing data, etc. The response generator 12 can receive inputs, provide outputs, generate responsive information, and/or output information regarding answers to natural-language prompts generated based on uniquely built context. The response generator 12 can be configured to receive inputs and/or provide outputs via a user interface 24. The response generator 12 can include hardware, firmware, and/or stored software. The response generator 12 can be entirely or partially mounted on one or more circuit boards. It is understood that the functionality attributed to the response generator 12 herein can be distributed across one or more physical and/or virtual machines.

The response generator 12 can be a discrete assembly or be formed by one or more devices capable of individually or collectively implementing functionalities and generating and outputting data as discussed herein. The response generator 12 can, in some examples, be considered to form a single computing device even when distributed across multiple component devices. The response generator 12 is configured to perform any of the functions attributed herein to the response generator 12, including receiving an output from any source referenced herein, detecting any condition or event referenced herein, and generating and providing data and information as referenced herein. The response generator 12 can be of any type suitable for operating in accordance with the techniques described herein. In some examples, the response generator 12 can be implemented as a plurality of discrete circuitry subassemblies. In some examples, the response generator 12 can include or be implemented at least in part as a smartphone or tablet, among other options. In some examples, the response generator 12 can include and/or be implemented as downloadable software in the form of a mobile application. The mobile application can be implemented on one or more computing devices, such as a personal computer, tablet, and/or smartphone, among other suitable devices.

The response generator 12 can include control circuitry 20, memory 22, and a user interface 24. The control circuitry 20, in one example, is configured to implement functionality and/or process instructions. Examples of control circuitry 20 can include one or more of a processor, a microprocessor, a controller, a digital signal processor (DSP), an application specific integrated circuit (ASIC), a field-programmable gate array (FPGA), a graphics processing unit (GPU), a system-on-module (SOM), or other equivalent discrete or integrated logic circuitry. Control circuitry 20 is configured to execute the software or other code stored by the memory 22 to perform various functions referenced herein. The control circuitry 20 can be entirely or partially mounted on one or more circuit boards.

Memory 22 can be configured to store data and information before, during, and/or after operation. The memory 22, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, the memory 22 is a temporary memory, meaning that a primary purpose of the memory is not long-term storage. The memory 22, in some examples, is described as volatile memory, meaning that the memory 22 does not maintain stored contents when power to the response generator 12 is turned off. Examples of volatile memories can include random access memories (RAM), dynamic random access memories (DRAM), static random access memories (SRAM), and other forms of volatile memories. In some examples, the memory 22 is used to store program instructions for execution by the control circuitry 20. The memory 22, in one example, is used by software or applications running on the response generator 12 (e.g., by one or more language models, etc.) to temporarily store information during program execution.

The memory 22, in some examples, also includes one or more computer-readable storage media. The memory 22 can be configured to store larger amounts of information than volatile memory. The memory 22 can further be configured for long-term storage of information. In some examples, the memory 22 includes non-volatile storage elements. Examples of such non-volatile storage elements can include magnetic hard discs, optical discs, flash memories, or forms of electrically programmable memories (EPROM) or electrically erasable and programmable (EEPROM) memories.

As illustrated in FIG. 1, the memory 22 can be configured to include chat module 26, context generation module 28, and language generation module 30. Modules 28, 30, 32 can take the form of computer-readable instructions that, when executed by control circuitry 20, cause the response generator 12 to implement functionality attributed herein to modules 28, 30, 32. Though the example of FIG. 1 is described with respect to separate modules 28, 30, 32, it is understood that the techniques described herein with respect to such modules 28, 30, 32 can be implemented in a single module or multiple modules (e.g., two, three, four, etc.) that distribute functionality attributed herein to modules 28, 30, 32 among the multiple modules. In general, memory 22 can store computer-readable instructions that, when executed by control circuitry 20, cause response generator 12 to operate in accordance with techniques described herein.

User interface 24 is an input and/or output device and/or software interface, and enables an operator, such as a user, to control operation of and/or interact with software elements of response generator 12. For example, user interface 24 can be configured to receive inputs from the user and/or provide outputs to the user. In one example, the user interface 24 can be configured to receive inputs from a user, such as response requests, and/or can provide information responsive to a request from a user, among other information. Examples of the user interface 24 can include one or more of a sound card, a video graphics card, a graphical user interface (GUI), a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines. The user interface 24 can be formed, at least partially, by the user device 14.

Response generator 12 is a network-connected device that is connected to network 18 as well as local user device 14 and databases 16a-n. Response generator 12 also includes or more hardware elements, devices, etc. for facilitating electronic communication with network 18 (e.g., wide area network (WA) and/or local area network (LAN)), databases 16a-n, local user device 14, and/or any other suitable device via one or more wired and/or wireless connections. It is understood that response generator 12 can be formed by any one or more suitable network-connectable computing device(s) for performing the functions of response generator 12 detailed herein.

Network 18 is configured for connecting computing devices. Network 18 can be configured as a local area network and/or a wide area network suitable for connecting computing devices (e.g. response generator 12) and other computing devices that are separated by greater geographic distances than the devices of a local network. Network 18 can include network infrastructure for connecting devices separated by larger geographic distances. In at least some examples, network 18 is the Internet. Response generator 12 can communicate with database 16, and user device 14 via network 18. In some examples, components implementing functionality attributed herein to response generator 12 can be communicatively connected via network 18.

As will be described in more detail subsequently, response generator 12 generates natural-language text responses based on user-provided natural-language prompts. In at least some examples, response generator 12 can generate natural-language text responses for a chat service, such that the user-provided prompts and natural-language text responses generated by response generator 12 mimic a conversation between two humans. Users can access chat functionality of response generator 12 by directly accessing response generator 12 (e.g., by user interface 24) and/or by accessing the functionality of response generator 12 through another device, such as user device 14.

User device 14 is a user-accessible electronic device that is directly connected to response generator 12 and/or is connected to response generator 12 via network 18. User device 14 includes device control circuitry 32, device memory 34, and device user interface 36, which are substantially similar to control circuitry 20, memory 22, and user interface 24, respectively, and the discussion herein of control circuitry 20, memory 22, and user interface 24 is applicable to device control circuitry 32, device memory 34, and device user interface 36, respectively. User device 14 can be, for example, a personal computer or any other suitable electronic device for performing the functions of user device 14 detailed herein. Device memory 34 can store software elements of chat client 38, which will be discussed in more detail subsequently and particularly with respect to the function of chat module 26 of response generator 12.

Databases 16a-16n are electronic databases that are directly connected to response generator 12 and/or are connected to response generator 12 via network 18. Each of databases 16a-16n includes machine-readable data storage capable of retrievably housing stored data, such as database or application data. In some examples, one or more of databases 16a-16n includes long-term non-volatile storage media, such as magnetic hard discs, optical discs, flash memories and other forms of solid-state memory, or forms of electrically programmable memories (EPROM) or electrically erasable and programmable (EEPROM) memories. Each of databases 16a-16n can include control circuitry, at least one memory, and a user interface that are substantially similar to control circuitry 20, memory 22, and user interface 24 of response generator 12. In some examples, databases 16a-16n can be partitions of a single database and, in yet further examples, system 10 can include only one database 16.

In at least some examples, one or more of databases 16 are vector databases. In such an example, one or more, up to all, of databases 16 can be an electronic database that stores vector information representative of natural-language text. The vectors stored in the vector database 16 are embedded as vectors using an embedding model/algorithm that transforms natural-language text into vectors representative of the text. The vectors can represent the words of the natural-language text (e.g., word vectors) and/or any other suitable element of the text. The natural-language text represented by the vectors of the vector database 16 can be, for example, generated based on various documents (e.g., policy documents, historical documents, previously answered questionnaires, etc.). The vectors of vector database can represent any suitable length of text, such as sentences, paragraphs, etc. In at least some examples, the vectors of the vector database 16 represent portions within documents.

The vectors can represent chunks of various documents. The chunks can be generated such that chunks representative of adjacent text within a single document overlap to include common text. For example, a first chunk can end with the first two sentences of the third paragraph of an example document and a second chunk can begin with those first two sentences of the third paragraph. Overlapping chunks ensure that all information within each document is captured and stored within the database 16.

In some examples, the databases 16 are store documents of different document types. For example, a first one of databases 16 can be configured to store internal documents, a second one of databases 16 can be configured to store outside documents, etc. In an example in which responses are generated based on client questionnaires, such as security assessment questionnaires (SAQs), a first database 16 can store internal policy documents, a second database 16 can store past SAQs and associated answers, a third database 16 can store information generated based on other information (e.g., a policy summary document), among other options.

To query database 16, response generator 12 (e.g., language model of language generation module 30) and/or database 16 can generate a vector embedding of query text and compare that vector to the vectors stored to database 16. The vector embedding of the query text is referred to herein as a “query vector” and the vectors of the database are referred to herein as “database vectors.” The query vector can be generated using the same embedding algorithm and/or have the same number of dimensions as the database vectors (i.e., the vectors of database 16). Vectors stored to vector database 16 having a similarity score above a particular threshold and/or having the highest overall similarity to the query vector can be returned in response to the query. Vector similarity can be assessed by cosine similarity, cartesian similarity, and/or any other suitable test for assessing vector similarity. The corresponding raw data (i.e., the raw text information) represented by the returned vectors can then be retrieved and provided to response generator 12.

Chat module 26 is a software element of response generator 12 and includes one or more programs for operating a chat application. The program(s) of chat module 26 receive user requests, such as from chat client 38 implemented on user device 14, and provide those user requests to context generation module 28. Chat module 26 is also able to provide responses generated by language generation module 30 to the user, such as via the chat client 38 implemented on the user device 14. In some examples, chat module 26 is configured to receive and/or request user credentials from the user and to limit access to the functionality of response generator 12 to users having valid user credentials. The user credentials can be one or more of a username, a password, or any other identifier suitable for identifying a particular user of the chat functionality of response generator 12. For example, chat module 26 can be configured to implement single sign on (SSO) authentication.

The user device 14 can be configured to implement the chat client 38 as one or more software applications that are able to provide user requests to response generator 12 and to receive responses from response generator 12. The chat client can be, in some examples, web browsers for accessing a web application implementing various functionalities of response generator 12, among other options.

A user request submitted to response generator 12 is a natural-language text string including, for example, one or more user queries, one or more instructions, one or more discussion topics, etc. The user request also includes build data. The build data defines the desired context for the response generator 12 to form the responsive output. In some examples, the build data includes a database identifier that identifies which of the one or more databases 16 are utilized to generate the response. In additional or alternative examples, the context identifier includes a target count. The target count provides the number of pieces of information (e.g., chunks, vectors, etc. from a database 16) utilized to generate the response.

In some examples, the build data can be selected from among multiple options for the build data. The response generator 12 can provide a data input for the user to provide the build data. The data input can be provided via the device user interface 36, among other options. In some examples, the data input can be in the form of an interactive display, such as by providing a plurality of drop-down menus. In one example, the data input includes a listing of the databases 16 and an associated count input for each database 16. The user can input the desired target count into the count input (e.g., by selecting from a dropdown menu, typing in a numeral, etc.) to provide the target count. The user not entering a target count for a particular database 16 can be treated as a null answer or a target count of zero. As such, the build data can, in some examples, include one or more database identifiers selected from a plurality of database identifiers and can include one or more associated target counts that can be selected from a plurality of target counts.

Context generation module 28 is a software element of response generator 12 and includes one or more programs for performing filtered querying of databases 16 by language generation module to generate the responsive output. Language generation module 30 is a software element of response generator 12 and includes one or more programs for generating outputs, such as natural-language outputs, based on natural language prompts. Language generation module 30 can be configured to query one or more, up to all, of databases 16a-16n to generate information responsive to a natural language prompt. Language generation module 30 can use one or more trained, computer-implemented machine-learning models to generate responses to prompts. The one or more trained, computer-implemented machine-learning models can be, for example, one or more language models, such as one or more large language models. The one or more language models can be, for example, one or more trained transformer models configured to generate natural-language outputs based on natural-language inputs. The one or more language models can be configured to use semantic searching to generate the responses to the prompts.

Context generation module 28 is configured to cause the language generation module 30 to query the databases 16a-16n based on the user request to generate initial response information. The context generation module 28 is configured to filter the initial response information generated by the language model to build modified response information. The modified response information includes a subgroup of the initial response information. The context generation module 28 can generate a responsive prompt based on the modified response information. The responsive prompt can include the natural-language prompt from the user request. The context generation module 28 can further cause the language generation module 30 to generate natural language responsive text based on the responsive prompt that is responsive to the user request. The context generation module 28 can generate and output a responsive output, including the natural-language responsive text, for the user.

In operation, a user provides a user request to response generator 12. For example, the user can provide the user request via user device 14 running an instance of chat client 38. The request includes a prompt and build data. The prompt is natural-language text and, in some examples, includes one or more requests. The build data includes at least one of a database identifier and a target count. The database identifier provides the identity of a database 16 containing information on which the responsive output is to be based. The target count includes a count of the number of pieces of information (e.g., vectors, chunks, etc.) for forming the modified response information. The build data can include one or more database identifiers and associated target counts. The database identifier and associated target count can be referred to as filter criteria. For example, the context identifier for a first request can include first filter criteria that identifies a first database 16a and provides an associated target count for information from that database 16a, can further include second filter criteria that identifies a second database 16b and provides an associated target count for information from that second database 16b, etc.

The context generation module 28 receives the user request, including the build data, from the chat module 26. The context generation module 28 causes the language generation module 30 to query the databases 16 based on the user request. The context generation module 28 can direct the language generation module 30 to query specific ones of the databases 16, which are databases 16 identified by the build data, based on the prompt from the user request. The language model queries the databases 16 and generates initial response information responsive to the prompt. The language generation module 30 can generate the initial response information by identifying information based on a relevancy score between the prompt and the vectors, such as based on a semantic similarity, among other options.

The context generation module 28 generates the modified response information based on the initial response information returned by the language generation module 30. For example, if the build data includes a first target count of “three” for a first database 16a and a second target count of “two” for a second database 16b, the context generation module 28 will generate the modified response information based on three pieces of information returned from database 16a and two pieces of information returned from database 16b.

In some examples, the information stored in a database 16 includes a source document identifier. For example, the source document identifier can be part of the vector embedding of the information. The source document identifier provides the identity of the document from which the information was generated. For example, each chunk of information generated from a common document can include the same document identifier, which indicates that each chunk is from that common document.

In some examples, the response generator 12 is configured to filter the initial response information to generate the modified response information. The response generator 12 can be configured to filter the initial information based on uniqueness criteria. The uniqueness criteria provides one or more parameters by which the initial response information is filtered. In some examples, the uniqueness criteria can provide a source limit, which can provide for filtering based on the provenance of the information. For example, the source limit can provide for filtering based on the identity of the source document for each piece of information.

In some examples, the context generation module 28 can filter the initial information provided by the language model to generate the modified response context. The context generation module 28 can filter the initial information based on the uniqueness criteria, among other options. For example, the source limit can indicate that the modified response context include only a single piece of information from any source document. In such an example, the context generation module 28 can filter the pieces of information to form the modified response context based on relevance and provenance.

The initial response information could include multiple pieces of information from the same document. The initial response information could include multiple pieces of information from a single document that each have a higher relevance than the most relevant piece of information from other documents. Filtering the initial response information based on the source document identifier prevents source redundancy and can provide for higher confidence answers by preventing use of the same information multiple times in generating the responsive output.

Table 1 below shows an example in which information provided from database 16a is sorted based on relevance, and for which the source document is also identified. As shown, the initial information includes vector embeddings from three different source documents.

TABLE 1

| | Source | Embedding | Relevance | Uniqueness |
|---|---|---|---|---|
| Row | Document ID | Vector | Score | Score |
| R1 | 00001215 | 0.4, 0.2, 0.9, . . . | 87.3 | 1 |
| R2 | 00001215 | 0.6, 0.3, 0.7, . . . | 85.4 | 0 |
| R3 | 00001318 | 0.1, 0.5, 0.4, . . . | 79.5 | 1 |
| R4 | 00001318 | 0.6, 0.8, 0.2, . . . | 78.7 | 0 |
| R5 | 00001215 | 0.5, 0.1, 0.5, . . . | 78.4 | 0 |
| R6 | 00489574 | 0.9, 0.8, 0.1, . . . | 77.8 | 1 |

Assuming the build data includes a target count of three, three of the pieces of information will be used to build the modified response information. The uniqueness criteria can be applied to the pieces of information based on the source for each piece of information. In the example shown, the source limit is to include a maximum of one piece of information from any one source document. In such an example, the uniqueness score can be binary, such that the piece of information either satisfies or does not satisfy the uniqueness criteria. In the example shown in Table 1, the uniqueness score is binary and indicated as either “1” or “0.” A score of “1” indicates that that piece of information satisfies the uniqueness threshold and a score of “0” indicates that the piece of information does not satisfy the uniqueness threshold. In this example, the uniqueness threshold is satisfied by the most relevant piece of information from any one document.

The response generator 12 filters the information returned by the language model based on the uniqueness score. The response generator 12 can disregard the pieces of information that do not satisfy the uniqueness threshold. With continued reference to Table 1, the response generator 12 utilizes the pieces of information in rows R1, R3, and R6. The pieces of information in rows R2 and R5 are from the same document as the piece of information in row R1. The pieces of information in rows R2 and R5 can be filtered out and disregarded based on those pieces of information being less relevant than another piece of information from the same source document. Similarly, the piece of information indicated in row R4 is disregarded because it is from the same source document as the more relevant piece of information indicated in row R3. Response generator 12 can perform such filtered retrieval for each database 16 from which information is retrieved based on the user request.

It is understood that, in some examples, the response generator 12 can cause the language model to iteratively query the databases 16 to generate the modified response information. For example, the response generator 12 can cause the language model to query the database 16 until enough pieces of information are generated that satisfy the filter criteria for information from that database 16.

The response generator 12 can filter the initial response information such that pieces of information having relatively lower relevance scores are included in the modified response information over pieces of information having relatively higher relevance scores. Filtering the pieces of information based on source document identity provides consistency among generated answers while providing wider context for ultimate response generation. Such filtering provides the user with high confidence in the accuracy of the responsive output provided by the response generator 12.

The response generator 12 can cause the language model to simultaneously query the multiple databases 16a-16n to generate the initial information. For example, if the build data includes filter criteria for multiple of the databases 16a-16n, the response generator 12 can cause the language model to simultaneously query the multiple databases 16a-16n until information satisfying the filter criteria for each database 16a-16n is generated.

The response generator 12 builds the modified response information based on the filtered information. The response generator 12 utilizes the pieces of information that satisfy the request provided by the build data to build the modified response information. In some examples, the response generator 12 can label each piece of information in the modified context with an information identifier when building the modified response information. The information identifier can uniquely identify each piece of information in the modified response information relative to the other pieces of information in the modified response information. For example, the information identifier can label a first piece of information as “document 1,” a second piece of information as “document 2,” etc.

The response generator 12 provides a filtered request to the language model to cause the language model to generate responsive text for the user request. The filtered request, which can also be referred to as a responsive prompt, includes the user-supplied prompt and the modified response information. The response generator 12 causes the language model to generate natural language responsive text based on the responsive prompt.

In some examples, the response generator 12 is configured to provide a user identifier with the filtered request. The user identifier can provide identifying information regarding the user and/or the nature of the request. In some examples, the user identifier can indicate a role associated with the user. The user identifier provides additional context to the language model to cause the language model to generate responsive text applicable to the user. The user identifier can orient the language model for generating the natural language responsive text. For example, the user identifier can identify the user as information security personnel, a systems engineer, etc.

The user identifier can, in some examples, be generated based on an identity of the user, such as an identity tied to the SSO of the user for accessing the response generator 12. The user identifier can, in some examples, be generated based on a selection input by the user, such as at the user device 14. In some additional or alternative examples, the user identifier can be based, at least in part, on a chat history, such as a chat history stored by the chat client 38 and/or chat module 26. In some examples, the user can modify the user identifier by clearing all or portions of the chat history.

The response generator 12 can generate a modified prompt based on the user-supplied prompt and the user identifier. The response generator 12 can cause the language model to generate the responsive text based on the modified prompt. The modified prompt can instruct the language model to answer the user-supplied prompt from the perspective of a user identified by the user identifier. For example, in a system 10 for generating answers to SAQs, the modified prompt can instruct the language model to answer the user-supplied prompt from the perspective of information security personnel.

The response generator 12 causes the language model to generate natural language responsive text based on the modified response information and the user-supplied prompt. For example, the response generator 12 can provide the user-supplied prompt to the language model and instruct the language model to answer the user-supplied prompt based on the modified response information. The response generator 12 can provide the pieces of information forming the modified response information to the language model as unformatted chunks.

The language model generates responsive text based on the modified response information. The response generator 12 can output the responsive text to the user, such as via user device 14, as the response to the user request.

The response generator 12 can provide information in addition to the responsive text in the responsive output provided to the user. In some examples, response generator 12 is configured to provide a link to the information used to generate the responsive text. For example, the response generator 12 can provide an embedded link that can be selected by the user to recall and/or navigate to the source of the information. The link can be a link to the source document. The response generator 12 can, in some examples, provide a link to the one or more source documents from which the information forming the modified context.

In some examples, the response generator 12 can be configured to provide the pieces of information, such as the specific chunks of text, that form the modified response information in the responsive output. For example, the response generator 12 can provide the text itself, can provide a link that directs to the portion of the source document from which the piece of information was generated, can provide a modified version of the source document (e.g., highlighting the text forming the piece of information), among other options.

In some examples, the response generator 12 is configured to generate and provide annotated responsive text. In such an example, the response generator 12 can insert source identifiers, such as footnotes among other options, into the responsive text that indicates the piece or pieces of information that were utilized to form that portion of the responsive text. The source identifier can, in some examples, provide a link to the piece of information.

In some examples, the response generator 12 can provides a source list in addition to or alternatively to the source identifier. The source list can include a listing of the pieces of information forming the modified context. In some examples, the source list can include a listing of the source documents from which the pieces of information forming the modified context are generated. In some examples, the source list can include the link to the source document.

In some examples, the response generator 12 is configured to output relevancy information regarding the pieces of information forming the modified context. The relevancy information can be based on the relevance score for the pieces of information as retrieved by the language model. For example, the response generator 12 can provide an ordered source list, with the pieces of information in the source list sorted based on their relevancy scores. The ordered source list can be configured to list the pieces of information from higher to lower relevancy scores, among other options.

In some examples, the response generator 12 is configured to provide a null answer in response to the user request. The null answer can inform the user that an answer cannot be generated based on the user-supplied prompt. For example, the response generator 12 can determine that an answer cannot be generated based on a relevancy threshold. The relevancy threshold can be applied when generating the modified response information and/or when generating the initial response information by the language model. In some examples, the relevancy threshold can be applied by the language model. For example, the language model can be configured to return only pieces of information that meet the relevancy threshold. If there is insufficient information to generate the modified response information (e.g., no pieces of information that satisfy the relevancy threshold, fewer pieces of information satisfying the relevancy threshold than specified by the build data, etc.) then the response generator 12 can provide the null answer as the responsive answer. The null answer indicates that there is insufficient information to provide an answer to the user request.

In some examples, the response generator 12 is configured to receive feedback from the user. In some examples, one or more icons can be provided, such as via the device user interface 36, by response generator 12 to facilitate receiving the feedback from the user. In some examples, the user feedback can be provided in a binary manner. In some such examples, the user feedback can be indicated as one of positive, indicating that the responsive text was actually responsive to the user request, and negative, indicating that the responsive text was not actually responsive to the user request. In some examples, the response generator 12 can be configured to consider no response, such as the user proceeding with another search before responding, as a positive response.

The response generator 12 can generate and output a service request based on a response status of the responsive output. The response status can indicate whether the response generator 12 was able to generate an acceptable response to the user request. In some examples, the response status can be binary. For example, the response status can be one of satisfactory or unsatisfactory. The response status can, in some examples, be based on one or both of the answer status (e.g., whether a null answer was provided) and the user feedback. In some examples, the response status can be determined to be unsatisfactory based on a null answer being generated. In additional or alternative examples, the response status can be determined to be unsatisfactory based on the user feedback being negative.

The service request can be provided, such as over network 18, to a servicer. The service request can indicate the user prompt from the user request and, in some examples, the basis (e.g., the answer status, user feedback, etc.) for the unacceptable response status, The service request can, in some examples, direct the servicer to the user, such as via a user identity provided via the sign on to the response generator 12, such as to direct the user to resources for answering the user prompt. In an SAQ example, the servicer can direct the user to internal resources (e.g., other users, documents not in a database 16, etc.) to facilitate answer generation.

In some examples, response generator 12 is configured to generate responsive answers and populate a document with the responsive answers to generate a response document. As discussed above, entities, such as companies, can be required to answer security assessment questionnaires (SAQs) prior to engaging with outside entities (e.g., vendors and/or customers). Such SAQs can be lengthy and include many questions regarding internal policies and procedures; how such policies and procedures are implemented; and regarding the use of security to protect various assets; among other things. Some outside entities can require answering of multiple SAQs, such as on a periodic basis (e.g., annually, bi-annually, semi-annually, etc.). Each SAQ can include multiple distinct questions, up to hundreds of questions.

A query document, such as an SAQ, can be provided to the response generator 12. The query document can include multiple, up to hundreds or more, of individual questions that require answering. Each individual question can be considered to form a prompt. The response generator 12 can perform the filtered query approach to generate responsive answers to the multiple questions in the query document. The response generator 12 can generate responsive answers to the questions in the query document and add such answers to the query document to generate the response document.

In examples in which response generator 12 is configured to generate a response document, the build data provided to the response generator 12 can be document-level or question-level. Document-level build data applies the same build data across the query document. In such an example, the response generator 12 can utilize the same filter criteria (e.g., which database 16 to search, the target count, etc.) to generate responsive text for each question in the query document. Question-level build data applies specified build data for a question, which specified build data can vary from other build data for other questions in the query document.

Response generator 12 provides significant advantages. Response generator 12 utilizes a filtered query approach to retrieve contextual information used to build prompt context for answering the prompt by a language model. The filtered query approach can reduce fabrications (e.g., AI hallucinations) created by the language model and also increase the accuracy of responses generated by the language model. The filtered query approach can provide for consistency of responses generated by the language model thereby increasing the value of those responses for users.

The modified response information is generated based on build data. The modified response information forms the context for answering the user supplied prompt in a user request. The build data provides information regarding the database 16 to be queried and an associated target count for querying the database. The build data facilitates narrowing and widening of both the databases 16 utilized to generate responsive outputs and the document base utilized to generate the responsive answer. The build data provides for specific, directed responses that are of high value.

The filtered query approach can filter the information retrieved by the language model to prevent source redundancy when building the prompt context. For example, the response generator 12 can be configured to filter the information based on source document identity to limit the amount of information in the modified context that comes from any single source. In some such examples, the response generator 12 can utilize less relevant information over more relevant information based on the less relevant information being from a unique source. Filtering the initial information based on the source identity prevents redundancy in the information forming the modified context and provides for consistent answers with high confidence for the user.

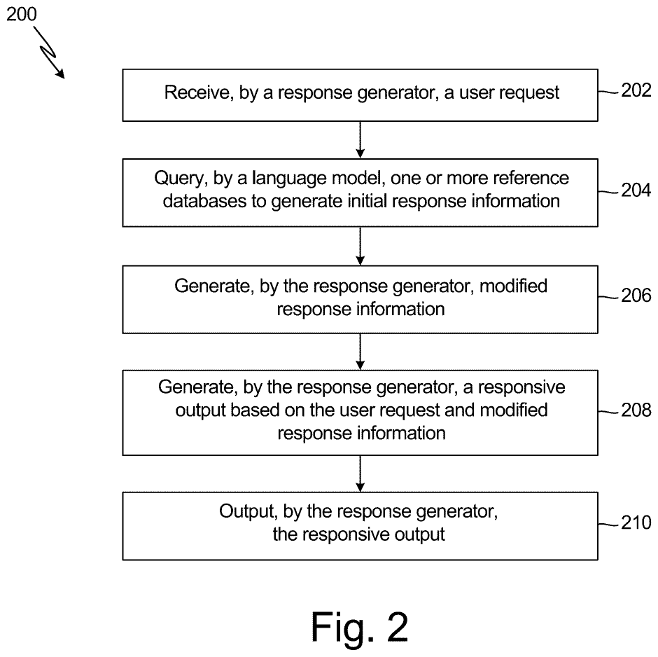

FIG. 2 illustrates method 200 of applying a filtered query approach to generate a responsive output to a user request. In step 202, a user request is generated and provided to a response generator, such as response generator 12.

The user request includes a user-supplied prompt. The user-supplied prompt can be a natural language input. The user-supplied prompt can be provided directly by the user, such as via a chat client, and/or can be generated by the response generator, such as based on optical character recognition (OCR) of an uploaded questionnaire document, among other options.

The user request further includes build data. The build data provides build parameters for generation of the responsive output. The build parameters can be associated with various reference databases, such as databases 16a-16n. The build parameters can include, among others, one or more database identifiers and one or more target response counts.

In step 204, the response generator causes a language model, such as a large language model (LLM) among other options, to query the one or more reference databases. The response generator causes the language model to query the reference databases based on the user supplied prompt and the build data. The response generator can cause the language model to simultaneously and iteratively query the reference databases to generate initial response information. The initial response information can be formed by text segments recalled from the one or more reference databases.

The response generator can cause the language model to query only those reference databases that are indicated as relevant by the build data. For example, the build data for a particular reference database can include a document count of “zero” or other null signifier, indicating that that particular reference database is irrelevant and should not be utilized in generating the initial response information. In such an example, the reference database is indicated as irrelevant by signifying that no documents from that particular reference database should be considered in generating the responsive answer.

In step 206, modified response information is generated based on the initial response information generated by the language model. The modified response information is generated based on the build data. It is understood that, in some examples, response generator 12 can be configured to simultaneously perform any one or more of the steps discussed herein. For example, the response generator 12 can be configured to simultaneously cause the language model to query the one or more reference databases while generating the modified response information. For example, the response generator 12 can cause the language model to iteratively query a reference database until the responsive information provided by the language model satisfies the build parameters (e.g., until the number of text segments recalled meets the target count for a particular reference database 16).

The modified response information can be generated based on one or more filter parameters. For example, the modified response information can be based on a relevancy parameter, a uniqueness parameter, among other options. In one example, the modified response information is generated based on a uniqueness parameter. The uniqueness parameter can specify, for example, that the modified response information includes only a certain number of text segments from any one source document. In some examples, the uniqueness parameter can specify that the modified response information include up to only a single text segment from any one source document.

In some examples, the response generator 12 is configured to label the text segments that form the modified response information. In such examples, the modified response information can be considered to include labeled text segments. The text segments can be labeled to uniquely identify the text segments relative to one another by the labels. For example, each text segment can be labeled as a different “document,” with the modified response information formed by one or more such “documents.”

In step 208, the response generator generates the responsive output. The responsive output is generated based on the user request and the modified response information. For example, the response generator can generate a responsive prompt based on the modified response information. The response generator causes the language model to generate the responsive text based on the modified response information. The response generator can be configured to cause the language model to generate natural language responsive text based on the modified response information and the user supplied prompt.

In some examples, the response generator can cause the language model to generate the responsive text based on a modified prompt. For example, in a system for generating answers to SAQs, the modified prompt can instruct the language model to answer the user-supplied prompt from the perspective of information security personnel.

In some examples, the response generator is configured to generate and output information in addition to the natural language responsive text. For example, the response generator can provide an embedded link that can be selected by the user to recall and/or navigate to the source of the information. In some examples, the response generator can provide a list of the source documents used to generate the modified response information. In some examples, the list of source documents can include a synopsis of the document or relevant text chunk, among other options.

In some examples, the response generator can be configured to provide the pieces of information, such as the specific chunks of text, that form the modified response information in the responsive output. For example, the response generator can provide the text itself, can provide a link that directs to the portion of the source document from which the piece of information was generated, can provide a modified version of the source document (e.g., highlighting the text forming the piece of information), among other options.

In some examples, the response generator is configured to generate annotated responsive text. The response generator can insert source identifiers, such as footnotes among other options, into the responsive text that indicates the piece or pieces of information that were utilized to form that portion of the responsive text. The source identifier can, in some examples, provide a link to the piece of information.

In step 210, response generator provides the responsive output to the user. For example, the response generator can provide the responsive output to the user via a device user interface of a user device (e.g., device user interface 36 of user device 14). The response generator can provide the natural language responsive text to the user along with other responsive information, such as the annotations in the responsive text, the document links, the source list, etc. In some examples, the response generator 12 can solicit feedback from the user with the responsive output, such as via a prompt provided by the device user interface 36 of the user device 14.

Method 200 provides significant advantages. Method 200 utilizes the filtered query approach to generate the responsive output. The filtered query approach facilitates directed answer generation, while reducing fabrications (e.g., AI hallucinations) created by the language model, and also increasing the accuracy of responses generated by the language model. The filtered query approach can provide for consistency of responses generated by the language model thereby increasing the value of those responses for users. The filtered query approach provides confidence in the responsive output. The filtered query approach can prevent source redundancy and provides for high quality informative outputs. Further, reducing the overall quantity of text provided to a language model (or other computer-implemented machine-learning model configured to generate natural-language) as context (e.g., via RAG or a RAG-like approach) can reduce the computational cost associated with generating response text and, accordingly, can reduce the overall time required to generate the response text.

The filtered query approach can significantly reduce the time and effort required to generate responses to similar but nuanced questions. The filtered query approach facilitates quick response and turnaround when answering questionnaires, which can be lengthy and require varied information from different sources to answer. The filtered query approach reducing turnaround time and providing high quality responses provides more economic opportunity.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the present disclosure.

1. A method comprising:
receiving, by a processor of a response generator, a user request including a natural-language prompt and build data, the response generator formed as a network-connected device, the build data including a first database identifier selected from a plurality of database identifiers and a first target count associated with the first database identifier;
querying, by a language model, a first vector database identified by the first database identifier based on the natural-language prompt to retrieve first initial information, wherein:
the first vector database comprises a first plurality of vectors;
each vector of the first plurality of vectors is representative of a text segment of a first plurality of text segments, the first plurality of text segments generated based on a first plurality of documents; and
the first initial information includes text segments of the first plurality of text segments;
generating, by the response generator in response to receiving the first initial information, modified response information including a first count of text segments of the first plurality of text segments, the modified response information based on the first initial information and the build data, and the first count of text segments generated based on the first target count;
generating, by the response generator, a responsive prompt based on the modified response information and the natural-language prompt;
providing, by the response generator, the responsive prompt to the language model to generate natural-language responsive text; and
outputting, by the response generator, a responsive output that includes the natural-language responsive text.

2. The method of claim 1, further comprising:
determining a source identifier for each text segment of the first plurality of text segments in the first initial information, the source identifier indicating which document of the plurality of documents is a source of the text segment; and
generating, by the response generator, the modified response information based on the source identifiers.

3. The method of claim 2, wherein generating, by the response generator, the modified response information based on the source identifiers includes filtering the first initial information such that the modified response information includes no more than one text segment of the first plurality of text segments from any document of the first plurality of documents.

4. The method of claim 1, further comprising:
querying, by the language model, a second vector database identified by a second database identifier of the build data based on the natural-language prompt to retrieve second initial information, wherein:
the second vector database comprises a second plurality of vectors;
each vector of the second plurality of vectors is representative of a text segment of a second plurality of text segments, the second plurality of text segments generated based on a second plurality of documents; and
the second initial information includes text segments of the second plurality of text segments; and
generating, by the response generator, the modified response information based on the first initial information and the second initial information, the modified response information including a second count of text segments of the second plurality of text segments, the second count of text segments generated based on the second target count.

5. The method of claim 1, wherein generating, by the response generator, the modified response information further comprises:
filtering, by the response generator, the first initial information based on a source document identifier for each text segment of the first plurality of text segments forming the first initial information and based on a source document threshold.

6. The method of claim 5, wherein generating, by the response generator, the modified response information comprises including a first text segment from the first initial information in the modified response information and omitting a second text segment from the first initial information from the modified response information based on a relevancy score of the first text segment being higher than a relevancy score of the second text segment and based on the first text segment and the second text segment having a common source document.

7. The method of claim 6, wherein generating, by the response generator, the modified response information comprises including a first text segment from the first initial information in the modified response information and omitting any other text segment having a common source document with the first text segment from the first initial information.

8. The method of claim 1, further comprising:
generating, by the response generator, a document list including a source document of each text segment of the first plurality of text segments; and
outputting, by the response generator, the document list in the responsive output.

9. The method of claim 8, further comprising:
providing, by the response generator, a hyperlink to the source document.

10. The method of claim 8, further comprising:
providing, by the response generator, a hyperlink to a portion of the source document on which the text segment of the first plurality of text segments is based.

11. The method of claim 8, further comprising:
annotating, by the response generator, the natural-language responsive text with at least one source document identifier, the source document identifier indicating a source document of the text segment of the first plurality of text segments on which an associated portion of the natural-language responsive text is based.

12. The method of claim 1, further comprising:
receiving, by the response generator, a data request including a plurality of natural-language inquiries, the data request generated based on a questionnaire;
for each natural-language inquiry of the plurality of natural-language inquiries, utilizing the natural-language inquiry as the natural-language prompt to generate a natural-language answer associated with the natural-language inquiry; and
inputting the natural-language answers into a responsive document to generate a completed questionnaire.

13. The method of claim 1, further comprising:
labeling, by the response generator, each text segment of the first plurality of text segments forming the modified information with a unique identifier to generate labeled text segments; and
generating, by the language model, the natural-language responsive text based on the natural-language prompt and the labeled text segments.

14. A method comprising:
receiving, by a processor of a response generator formed as a network-connected device, a user request including a natural-language prompt and build data, the build data including first filter criteria for a first database and second filter criteria for a second database;
iteratively querying, by a language model, a first vector database identified by the first filter criteria based on the natural-language prompt to retrieve first initial information, wherein:
the first vector database comprises a first plurality of vectors;
each vector of the first plurality of vectors is representative of a text segment of a first plurality of text segments, the first plurality of text segments generated based on a first plurality of documents; and
the first initial information includes at least one text segment of the first plurality of text segments;
iteratively querying, by the language model, a second vector database identified by the second filter criteria based on the natural-language prompt to retrieve second initial information, wherein:
the second vector database comprises a second plurality of vectors;
each vector of the second plurality of vectors is representative of a text segment of a second plurality of text segments, the second plurality of text segments generated based on a second plurality of documents; and
the second initial information includes at least one text segment of the second plurality of text segments;
generating, by the response generator, modified response information based on the first initial information, a first target count from the first filter criteria, the second initial information, and a second target count from the second filter criteria, the modified response information including a first count of text segments from the first initial information based on the first target count, and the modified response information including a second count of text segments from the second initial information, the first count of text segments generated based on the first target count and the second count of text segments based on the second target count;
generating, by the response generator, a responsive prompt based on the modified response information and the natural-language prompt;
providing, by the response generator, the responsive prompt to the language model to generate natural-language responsive text; and
outputting, by the response generator, a responsive output that includes the natural-language responsive text.

15. The method of claim 14, wherein generating, by the response generator, the modified response information comprises:
filtering the first initial information such that the modified response information includes no more than one text segment originating from any document of the first plurality of documents; and
filtering the second initial information such that the modified response information includes no more than one text segment originating from any document of the second plurality of documents.

16. The method of claim 14, further comprising
querying, by the language model, the first vector database and the second vector database simultaneously.

17. A method comprising:
receiving, by a processor of a response generator formed as a network-connected device, a natural-language prompt and build data, the build data including a first database identifier selected from a plurality of database identifiers, and a first target count selected from a first plurality of target counts;
querying, by a language model, a first vector database identified by the first database identifier and based on the natural-language prompt to retrieve first initial information, wherein:
the first vector database comprises a first plurality of vectors;
each vector of the first plurality of vectors is representative of a text segment of a first plurality of text segments;
the first plurality of text segments are generated based on a first plurality of documents; and
the first initial information includes at least one text segment of the first plurality of text segments;
generating, by the response generator, modified response information based on the first initial information and the build data, wherein the response generator filters the first initial information based on a source document identifier for the text segments of the first plurality of text segments, the modified response information including a first count of text segments of the first plurality of text segments, the first count of text segments generated based on the first target count;
generating, by the response generator, a responsive prompt based on the modified response information and the natural-language prompt;
providing, by the response generator, the responsive prompt to the language model to generate natural-language responsive text; and
outputting, by the response generator, a responsive output that includes the natural-language responsive text;
wherein the response generator is configured to include a first text segment from the first initial information in the modified response information and omit a second text segment from the first initial information from the modified response information based on a relevancy score of the first text segment being higher than a relevancy score of the second text segment and based on the first text segment and the second text segment having a common source document.

18. The method of claim 17, further comprising:
querying, by the language model, a second vector database identified by a second database identifier of the build data and based on the natural-language prompt to retrieve second initial information, wherein:
the second vector database comprises a second plurality of vectors;
each vector of the second plurality of vectors is representative of a text segment of a second plurality of text segments, the second plurality of text segments generated based on a second plurality of documents; and
the second initial information includes at least one text segment of the second plurality of text segments;
wherein the response generator generates the modified response information based on the second initial information.

19. The method of claim 18, further comprising:
iteratively querying, by the language model, the first vector database to generate the first initial information; and
iteratively querying, by the language model, the second vector database to generate the second initial information.

20. The method of claim 17, wherein outputting, by the response generator, the responsive output that includes the natural-language responsive text includes:
outputting, by the response generator, a citation list in the responsive output, the citation list including a source document listing for the text segments forming the modified response information.
